(19) United States
(12) Patent Application Publication
(10) Pub. No.: US 2016/0362210 A1
(43) Pub. Date: Dec. 15, 2016

(54) METHOD AND APPARATUS FOR FILLING AND LOADING FLEXIBLE POUCHES WITH SPOUTS IN A RETORT

(71) Applicant: Richard Dalton, Fontana, CA (US)

(72) Inventor: Richard Dalton, Fontana, CA (US)

(21) Appl. No.: 15/182,449

(22) Filed: Jun. 14, 2016

Related U.S. Application Data
(60) Provisional application No. 62/175,339, filed on Jun. 14, 2015.

(51) Int. Cl. B65B 55/02; A23L 3/12; B65B 55/10; B65B 3/04; B65B 7/02

(52) U.S. Cl. CPC B65B 55/022; B65B 3/045; B65B 7/02; B65B 55/10; A23L 3/12; A23V 2002/00

(57) ABSTRACT

Some embodiments of the invention include a food processing retort apparatus. The food processing retort apparatus may comprise a substantially sealable housing, which may include a plate and a port. In some embodiments, the plate may include a plurality of empty portions, each plurality of empty portions having an elongated portion and a plurality of cutouts. In some embodiments, the elongated portions may have a first width and the cutouts may have a second width, such that the first width is greater than the second width. In some embodiments, the port may allow entry of a heating liquid into the housing to process contents within the retort.

### RELATED APPLICATION

This application claims priority under 35 U.S.C. §119 to U.S. Provisional Application No. 62/175,339, filed Jun. 14, 2015, the entire disclosure of which is incorporated herein by reference.

### FIELD

This disclosure relates generally to food processing methods and apparatus such as cooking retorts for processing of food materials.

### BACKGROUND

An autoclave or retort, for example, may include a pressure chamber used to sterilize equipment and food products by subjecting them to high temperature and pressure saturated steam or water for such a period of time as to render the contents sterile. Generally the process is designed for at least 121° C. (250° F.) for around 15-20 minutes depending on the size of the load and the contents. These types of equipment are often used in commercial canning operations.

A retort pouch, for example, may include a type of food packaging made from a laminate of flexible plastic and metal foils. It allows the sterile packaging of a wide variety of food and drink handled by aseptic processing, and is used as an alternative to traditional industrial canning methods. Packaged foods range from water to fully cooked, thermo-stabilized (heat-treated) high-caloric (1,300 on average) meals such as Meals, Ready-to-Eat (MREs) which can be eaten cold, warmed by submersing in hot water, or through the use of a flameless ration heater, a meal component introduced by the military in 1992.

Some varieties of pouches, for example, may have a bottom gusset and are known as Stand-Up Pouches.

Retort pouches, for example, may use less packaging material than cans and sterilize at lower temperatures and in less time, which may improve food product quality, especially where color or texture are important. Retort pouches can be customized to any application and can be provided as flat or standup pouches, with or without recloseability.

One common method of providing recloseability to a pouch, for example, is by adding a spout fitment with a cap or closure. Such pouches are often referred to as “spout pouches.”

A retort pouch, for example, may be constructed from a flexible metal-plastic laminate that is able to withstand the thermal processing used for sterilization. The food is first prepared, either raw or cooked, and then sealed into the retort pouch. The pouch is then heated to 240-250° F. (116-121° C.) for several minutes under high pressure inside a retort or autoclave machine. The food inside is cooked in a similar way to pressure cooking. This process reliably kills all commonly occurring microorganisms (particularly Clostridium Botulinum), preventing it from spoiling. The packaging process is very similar to canning, except that the package itself is flexible. The lamination structure does not allow permeation of gases from outside into the pouch. For food products with less than 85% water activity or pH less than 4.6, the retort may be run at a lower temperature and/or less time, or the product may be filled into the pouches at a temperature high enough to mitigate risk from less thermophillic organisms than Clostridium Botulinum.

A common method for loading retort pouches into the retort, for example, is by use of specially designed racks that allow compartmentalization of each pouch in a horizontal orientation. It is an important feature of the sterilization process that the pouches are loaded in such a manner that they are not allowed to touch during the sterilization process. Another important feature of the sterilization process is the ability to allow water to flow through the racks and around the pouch. Rack designs generally try and maximize the number of pouches that can be loaded in the given volume while also allowing enough room for the heating fluid (water or steam) to contact the sides of the pouch. For this reason most racks are constructed with a screen or mesh that is in contact with the pouch. U.S. Pat. No. 3,971,629 describes such retorting trays.

Despite these design features, the mesh and horizontal geometry, for example, may limit and may restrict the rate of the heat transfer which results in “cold spots,” which refers to areas within the retort chamber that are lower temperature than others. Cold spots, for example, may result in uneven cooking and can result in over-processed, lower quality food in some pouches, or potentially undercooked pouches that pose a greater health risk to consumers. Attempts have been made at reducing the effect of cold spots by employing expensive equipment such as retorts that rotate the basket of racks during cooking.

The subject matter claimed herein is not limited to embodiments that solve any disadvantages or that operate only in environments such as those described above. Rather, this background is only provided to illustrate one example technology area where some embodiments described herein may be practiced.

### SUMMARY

Some embodiments of the invention may include a food processing retort apparatus. The food processing retort apparatus may comprise a substantially sealable housing, which may include a plate and a port. In some embodiments, the plate may include a plurality of empty portions, each plurality of empty portions having an elongated portion and a plurality of cutouts. In some embodiments, the elongated portions may have a first width and the cutouts may have a second width, such that the first width is greater than the second width. In some embodiments, the port may allow entry of a heating liquid into the housing to process contents within the retort.

In some embodiments, the cutouts may be shaped and configured to accept the geometry of a spout pouch fitment, such that an open section within the fitment may be slightly larger than the thickness of the plate.

In some embodiments, the first width may be greater than any diameter of the spout pouch fitment.

In some embodiments, the first width may also be greater than any diameter of a cap in the fitment of the spout pouch.

In some embodiments, the spout pouches may be vertically suspended from the cutouts.

In some embodiments, the first width may be smaller than a part of the fitment of the spout pouch, and the first width may also be larger than remaining parts of the fitment of the spout pouch.

In some embodiments, the plate may also include holes whereby optional handles or cables may be attached that can be used to lift the plate.

Some embodiments of the invention may include a food processing retort apparatus. The food processing retort apparatus may comprise a substantially sealable housing, which may include a rack and a port. In some embodiments, the rack may comprise a plurality of removable cross bars, each of the plurality of cross bars may include cutout portions having a first width, wherein the plurality of cross bars are disposed relative to one another with a second width between two adjacent cross bars of the plurality of cross bars. In some embodiments, the second width may be greater than the first width. In some embodiments, the port may allow entry of a heating liquid into the housing to process contents within the retort.

In some embodiments, the cutouts may be shaped and configured to accept the geometry of a spout pouch fitment, such that an open section within the fitment may be slightly larger than the thickness of the plate.

In some embodiments, the first width may be greater than any diameter of the spout pouch fitment.

In some embodiments, the first width may also be greater than any diameter of a cap in the fitment of the spout pouch.

In some embodiments, the first width may be smaller than a part of the fitment of the spout pouch, and the first width may also be larger than remaining parts of the fitment of the spout pouch.

In some embodiments, the plate may also include holes whereby optional handles or cables may be attached that can be used to lift the plate.

In some embodiments, the spout pouches may be vertically suspended from the cutouts.

Some embodiments of the invention may include a method of processing food products. In some embodiments, a plurality of spout pouches comprising a flexible receptacle and a fitment, may be loaded into a plurality of racks, each rack comprising a plate having a plurality of cross bars with cutouts, wherein the spout pouches are suspended into the racks from the cutouts. The loading may be followed by filling the plurality of spout pouches with food materials through an opening within the fitment. The opening within the fitment may then be closed using a cap. The racks may then be loaded into a cooking retort, to process the contents of the spout pouches by allowing a heating fluid including water and/or steam, to contact the sides of the spout pouches.

In some embodiments, the spout pouches may be vertically suspended from the cutouts.

In some embodiments, the plurality of cross bars in the rack may be removable.

In some embodiments, the cap may include hermetic closures.

In some embodiments, the plate may also comprise a plurality of elongated empty sections, alternately placed with each of the plurality of cross bars, and wherein a width of each elongated empty section is greater than a width of each cutout.

In some embodiments, the width of each elongated empty section may be smaller than a part of the fitment, and wherein the width of each elongated empty section may be greater than a remaining part of the fitment.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF DRAWINGS

FIG. 1 is a block diagram of an example method of thermal processing of foods according to some embodiments.

FIG. 2 is a perspective view of an example pouch fitment along with a cap.

FIG. 3 is a perspective view of an example assembled rack without any pouches loaded.

FIG. 4 is a perspective view of an example assembly of rack assemblies within a cooking retort, showing three assembled racks as they would appear loaded in a vertical retort. Spout pouches are not included in the illustration.

FIG. 5 is a perspective view of an example top section of a rack that employs a square geometry as opposed to the round geometry in FIG. 3 or FIG. 4.

FIG. 6 is a perspective view of an example rack top section that may be removable from the rack.

FIG. 7A and 7B are example prototype images for a top section and a bottom section of a rack.

FIG. 8 is an example racking system of an empty rack assembly.

FIG. 9 is an example racking system of a racking assembly, loaded with pouches.

FIG. 10 is an example side support for a rack in a rack assembly.

FIG. 11 is an example top view of racks loaded in a retort.

### DETAILED DESCRIPTION

Some embodiments of the invention relate to the processing of food, and more particularly to methods wherein flexible packages may be loaded in a rack preparatory for being filled, sealed, and processed in a retort or other cooking apparatus.

In some embodiments, a novel rack comprising of sectional plates, either permanently fixed to a rack or removable, have been described. In some embodiments, the plates may include cutouts allowing for the filling, capping, and thermal retort processing of contents within flexible spout pouches, to be completed in the same rack. In some embodiments, the novel rack may help simplify the method of processing of foodstuffs in flexible spout pouches in a preferable vertical orientation.

In some embodiments, an object of the present invention may be to provide a system whereby spout pouches may be loaded vertically onto racks, whether manually or automated, and may be placed immediately into the retort. In some embodiments, the racks may be capable of supporting the pouches by the fitment. Once loaded onto the racks, by either an automated or manual operation, the pouches may then be filled with foodstuff and a hermetic closure may be applied, by either a manual or automated operation. In some embodiments, the framework may consist of a top layer with cutouts that may be specially designed to match the geometry of the fitment and may be sufficiently rigid to support the fitment during application of the cap, supports on the sides of the rack that may keep the top layer suspended, and a bottom layer which may support the sides and may either connect to the top layer or may rest thereon without interference to the pouches.

In some embodiments, the method described herein may relate to the support of spout pouches during filling, capping, and processing in a cooking retort. In some embodiments, the processes of filling and capping may be performed on the same support that will hold the spout pouches within the retort. In some embodiments, a plurality of rows of pouch supports may comprise one layer of a rack, and said pouch supports may be removable or fixed to the rack. In some embodiments, a plurality of racks may be placed into a vertical retort or stacked and placed in a horizontal retort.

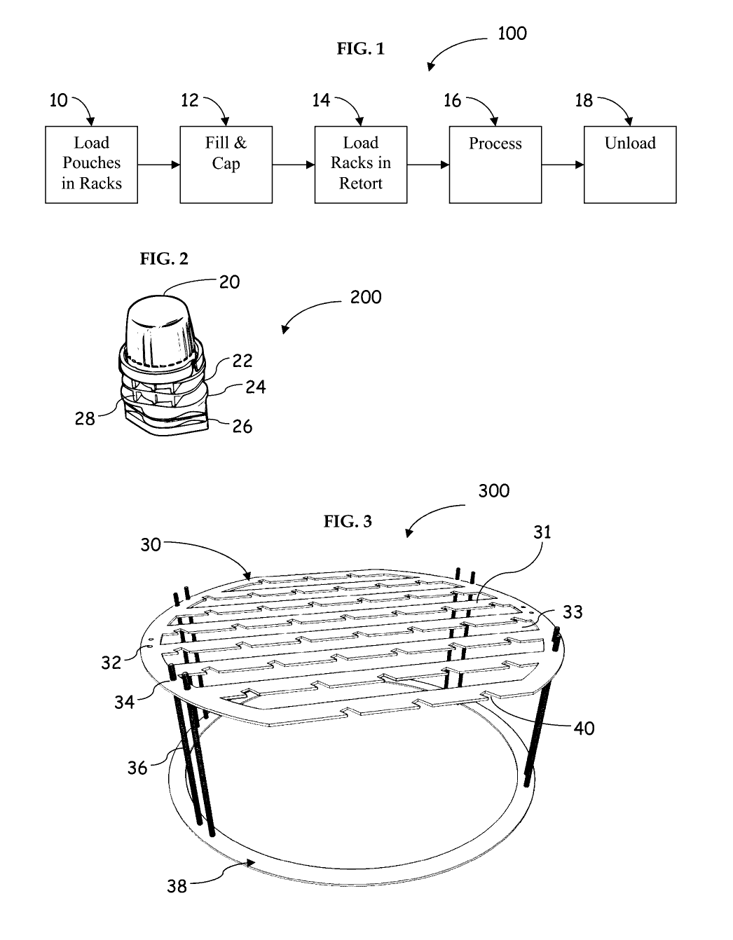

FIG. 1 is a block diagram of an example method 100 of thermal processing of foods in flexible spout pouches using the novel rack according to some embodiments. The apparatus and method for blocks 12, 14, 16, and 18 may be well known to those skilled in the art. Although illustrated as discrete blocks, various blocks may be divided into additional blocks, combined into fewer blocks, or eliminated, depending on the desired implementation.

At block 10 the pouches may be loaded into the racks. In some embodiments, the pouches may be loaded into the rack prior to being filled with the food materials while in other embodiments, the pouches may be loaded into the racks after being filled with the food materials. In some embodiments, the pouches may be loaded into racks manually while in other embodiments, the pouches may be loaded by an automated machinery. In some embodiments, machinery may be available that may form the pouch, fill it with food stuff, and then seal it. In some embodiments, the spout pouches may filled, and capped prior to being fixed to the rack and loaded into the retort, which may be advantageous for robotic automation or when working with a limited amount of space. In some embodiments, a worker may manually load the spout pouches onto a pre-assembled rack until the pre-assembled rack is completely full.

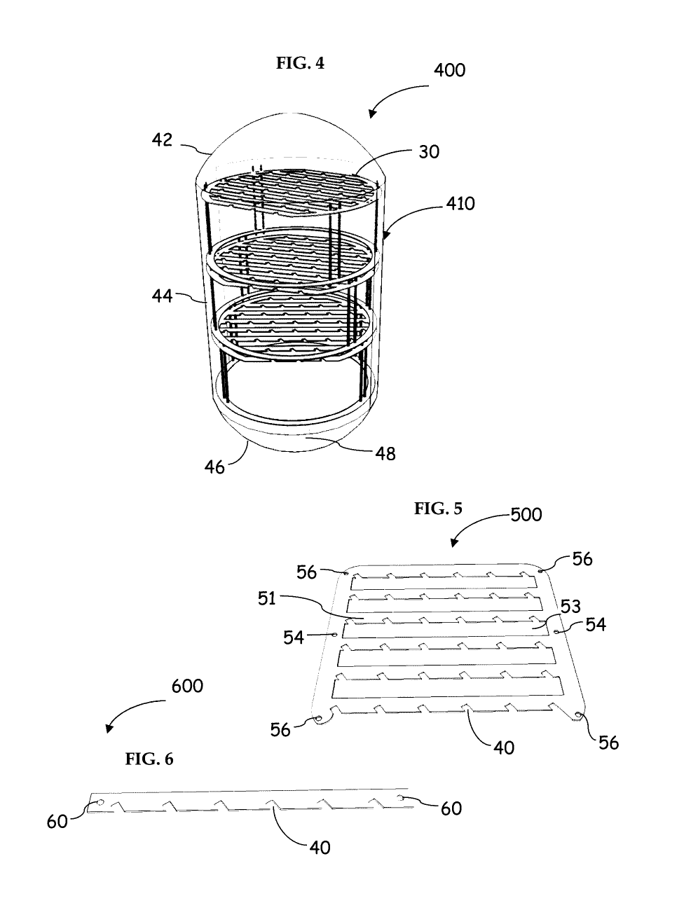

At block 12, the pouches loaded into the racks, may be filled with food materials and the opening of the pouch may be closed. In some embodiments, the opening of the pouches may include a fitment, through which the food materials may be filled into the pouches. In some embodiments, various methods may be employed with the machinery to add fitments such as, for example, fitment 200 as described in FIG. 2, to the pouches, wherein the fitments may be applied before the foodstuffs are filled while in other embodiments, the fitments may be applied after the foodstuffs are filled. In some embodiments, the machinery may commonly be referred to as a form, fill, seal machine by those skilled in the art. In some embodiments, a worker may insert a filling hose to each spout pouch fitment 200 and filling each pouch in sequence using a piston filler or timing pump filler. Such fillers are well known to those skilled in the art. In some embodiments, the worker may then position a cap, for example cap 20 as described in FIG. 2, on top of the fitment and sequentially tighten the cap by means of an electric or pneumatic manual capping machine. These capping machines are well known by those skilled in the art. In another embodiment, pre-manufactured pouches may be bought and then the pre-manufactured pouches may be filled with the food stuff through the fitment, followed by capping. In some embodiments, the cap may be applied to the fitment. In some embodiments, the cap may be hermetic closures. At block 14, the racks including the food-filled pouches may be loaded into a cooking retort apparatus. In some embodiments, the loading may be done vertically while in other embodiments, the loading may be done horizontally. In some embodiments, the racks loaded into the cooking retort may be as described in FIG. 4.

At block 16, the food materials in the pouches may be processed by the passage of a heating fluid throughout the interiors of the cooking retort. In some embodiments, a housing of the cooking retort may include a port and/or an opening to allow the entry of the heating fluid into the cooking retort. In some embodiments, the heating liquid may include water and/or steam. In some embodiments, the heating liquid may sterilize and or help cook contents of the pouches.

At block 18, the racks including the pouches may be removed from the cooking retort. The food materials within the pouches may now be cooked and the pouches including the contents of the pouches may also be sterilized.

FIG. 2 is an example fitment 200 for the pouches. In some embodiments, spout pouches may be pre-manufactured with a flexible film composed of materials for example, including polyester, polyethylene, polypropylene, or like webs of similar material, or a lamination of webs of similar material. In some embodiments, the spout pouches may have the fitment 200 which may be preinstalled whereby the flexible film may be adhered or bonded to the lower part 26 of the fitment 200. In some embodiments, these fitments may be installed at the top of a flexible pouch in order to form the spout pouch. In some embodiments, a cap 20 may be separate from the pouch and fitment at this point. In some embodiments, the spout pouch may be loaded onto a rack by sliding an open section between layer 22 and layer 24 of the fitment 200, over a cutout 40, wherein the cutout 40 is as described in FIG. 3. In some embodiments, the width of a fitment support 28 may match a width of the cutout 40 so that fitment 200 may fit in the cutout 40 snuggly and not rotate once in place.

FIG. 3 is an example rack assembly 300, wherein the racks may be pre-assembled as shown in the figure. In some embodiments, a top section 30 may comprise a plate that may include a plurality of cross bars 31, wherein the plurality of cross bars are disposed relative to one another such that they create alternate elongated empty portions 33. In some embodiments, the plate may also comprise plurality of cutouts 40 oriented in rows, wherein the plurality of cutouts 40 may be cut through in each of the cross bars 31. In some embodiments, width of each of the empty portions 33 may be greater than a width of each of the cutouts 40. In some embodiments, the width of each of the empty portions 33 may also be greater than any diameter of the fitment 200. The width of each of the empty portions 33 may also be greater than a diameter of the cap 20. In some embodiments, the width of each of the empty portions 33 may be smaller than a part of the fitment 200, and the width of each of the empty portions 33 may be larger than remaining parts of the fitment 200.

In some embodiments, the cutouts 40 may be oriented at some acute angle to the row resulting in nesting when the pouches are fully loaded in the rack. In some other embodiments, the cutouts 40 may be oriented perpendicular to the row if nesting is not an issue or to maximize flow around the pouch. In some embodiments, the top section 30 may also include holes 32 whereby optional handles or cables may be attached to make it easier to lift the entire rack assembly 300. In some embodiments, the handles or cables may be used to lift the top section 30 including the plate. In other embodiments, for larger racks, hardware may be necessary to connect crane cables to lift the rack. In some embodiments, the rack assembly 300 may also include a bottom section 38, which may comprise a plate that supports the rack assembly 300 when they may be stacked on each other, for example as seen in FIG. 4. In some embodiments, the plate of the bottom section 38 may be a ring shaped plate. In some embodiments, the rack assembly 300 may also comprise side supports 36 that may connect the top section 30 to the bottom section 38. In some embodiments, the plate of the bottom section 38 may include holes to accept side supports 36. In some embodiments, the side supports 36 may optionally allow for adjustable height as in this example, which may employ threaded rod for height adjustment. In some embodiments, nuts 34 may sandwich the plates of the top section 30 and the bottom section 38 keeping them fixed. In another embodiment, height adjustment may be accomplished by use of fixed side supports with pins that lock the top section 30 into the appropriate height of the side supports 36. In some embodiments, the open section between layer 22 and layer 24 of the fitment 200, may be slightly larger than and/or closely match a thickness of the plate in the top section 30 of the rack assembly 300 so that once in place the fitment is held in place without vertical play.

FIG. 4 is an example assembly 400 of multiple rack assemblies 300 stacked together in a cooking retort 410. In some embodiments, the cooking retort 410 may be a vertical retort. In some embodiments, during step 14 of method 100, the racks that may have been loaded with spout pouches, filled and capped, may then be loaded into the cooking retort 410 for thermal processing. In some embodiments, 42 may be a lid assembly which may allow operators to open the cooking retort 410 and lower the rack assemblies 300 therein. In some embodiments, after the rack assemblies 300 have been loaded, the retort lid 42 may be closed and tightened with a seal creating a closed vessel capable of maintaining above atmospheric pressures. In some embodiments, the body of the cooking retort 410 may most commonly be composed of cylindrical sides 44. While in some embodiments, cylindrical geometry may be used, other embodiments may comprise square geometries. The cooking retort 410, also known as the pressure vessel, may also include an end piece 46 that may or may not open. In embodiments, having horizontally oriented cooking retorts, it may be more common for both end pieces to open. In some embodiments, an inlet 48 and an outlet (not illustrated) may allow fluids, such as hot water or steam, to circulate through the cooking retort 410. Retort machinery designs are well known by those skilled in the art. In some embodiments, the rack assemblies 300 may be loaded into vertical retorts by a worker lowering the rack assemblies 300 into place manually, or for heavier racks, the worker may also utilize an overhead crane. In some embodiments, robotic machinery may also complete the task of loading the racks. For horizontal retorts, the racks may be typically stacked onto carts that may then be rolled into the cooking retort 410. The methods by which foodstuffs may be sterilized in the cooking retort 410 are well known by those skilled in the art.

FIG. 5 is an example top section 500 comprising a plate, within a rack assembly. In some embodiments, the top section 500 may include or correspond to the top section 30 as described in FIG. 3. In some embodiments, the top section 500 may include a square shaped plate to be placed within a square rack assembly that would also be pre-assembled. In some embodiments, the plate of the top section 500 may comprise a plurality of cross bars 51, wherein the plurality of cross bars are disposed relative to one another such that they create alternate elongated empty portions 53. In some embodiments, the cross bars 51 may correspond to the cross bars 31 of FIG. 3, and the empty portions 53 may correspond to the empty portions 33 of FIG. 3. The plate of the top section 500 may also comprise cutouts 40, wherein the plurality of cutouts 40 may be cut through in each of the cross bars 51. The cutouts 40 may correspond to the cutouts 40 as described in FIG. 3. In some embodiments, width of each of the empty portions 53 may be greater than a width of each of the cutouts 40. In some embodiments, the width of each of the empty portions 53 may also be greater than any diameter of the fitment 200. The width of each of the empty portions 53 may also be greater than a diameter of the cap 20. In some embodiments, the width of each of the empty portions 53 may be smaller than a part of the fitment 200, and the width of each of the empty portions 53 may be larger than remaining parts of the fitment 200. In some embodiments, side supports may be installed through holes 56. In some embodiments, the holes 56 may include or correspond to the holes at which the nuts 34 connect the side supports 36 to the top section 30, as described in FIG. 3. In some embodiments, fixtures may optionally be employed through holes 54. In some embodiments, the holes 54 may include or correspond to the holes 32, as described in FIG. 3. In some embodiments, square and rectangular geometries may be favorable for loading in horizontal cooking retorts or vertically oriented square and rectangular cooking retorts.

FIG. 6 is an example removable cross bar 600 of a plate in a top section. In some embodiments, the top section may be composed of removable crossbars 600. This embodiment may be especially useful for highly automated systems. The cross bar 600 may comprise cutouts 40, which may correspond to the cutouts 40 described in FIG. 3 and FIG. 5. In some embodiments, side supports and bottom sections may not be permanently fixed to the top section, when the top section comprises removable cross bars 600. In some embodiments, an opening 60 may allow for the removable cross bar 600 to be set on a preformed rack with a vertical pin for alignment. In other embodiments, a cart with rows of pins may be loaded with these removable cross bars 600, and then rolled into a horizontal retort. In some embodiments, the removable cross bars 600 may be loaded onto a conveyor by means of end pieces by robotic or manual means. The conveyor may move to a first station where spout pouches may be loaded on the removable cross bars 600. Then a second station may allow for the filling of the spout pouches. The next station may fix a cap, for example cap 20. In a final station, the removable cross bars 600 may be removed from the conveyor and loaded on a larger rack system with either pins or slots to hold the removable cross bars 600 in place.

In some embodiments, the side supports, for example side supports 36 may be designed in such a manner that no bottom section is needed between each layer of pouches, for example bottom section 38. In such embodiments, the removable sections may then be attached directly to the side supports and the retort basket may be loaded with all layers together.

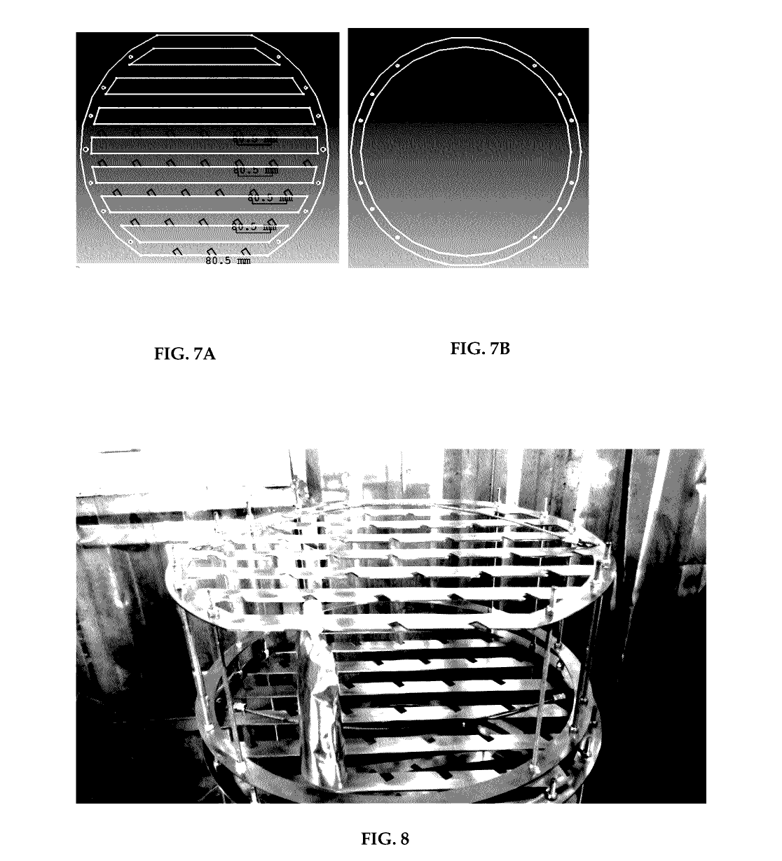

FIG. 7A and 7B are example prototype images for a top section and a bottom section of a rack. FIG. 7A may be an example top section that comprises a plate with cross bars. In some embodiments, the cross bars may be arranged alternately, such that alternate empty portions may be created. In some embodiments, the cross bars may be cut through to create cutouts, which may hold spout pouches. In some embodiments, the plate may comprise holes to insert cables or wires to lift the plate and/or the rack. In some embodiments, the plate may comprise holes to attach to side supports.

FIG. 7B may be an example bottom section of a rack, wherein the bottom section may include a plate which may support the side supports and may either connect to the top section or may rest thereon without interference to the spout pouches.

FIG. 8 is an example racking system of an empty rack assembly. In some embodiments, each rack assembly may comprise a plate with a plurality of cross bars, such that each cross bar may include cutouts that hold pouches. In some embodiments, the cutouts may be designed to fix the orientation of the pouches in such a manner as to allow proper fluid flow around the pouches.

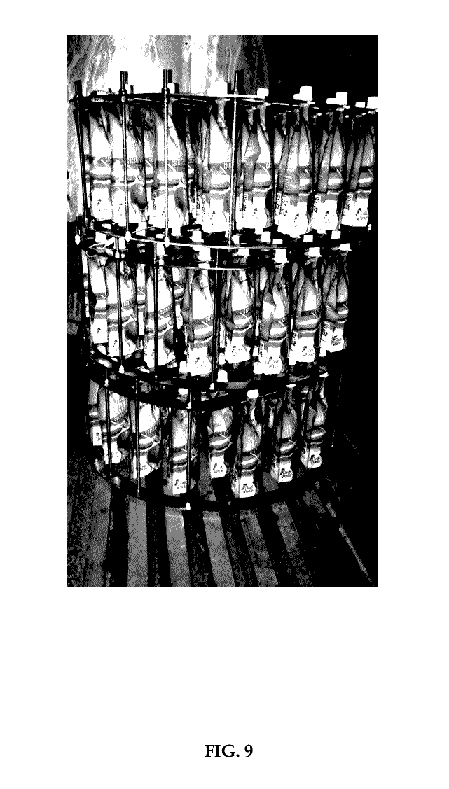

FIG. 9 is an example racking system of a racking assembly, loaded with pouches. In some embodiments, the racks may be fully loaded with filled pouches prior to loading in a vertical retort.

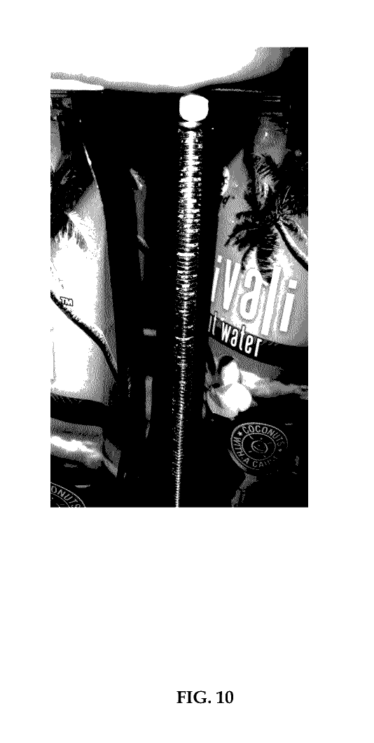

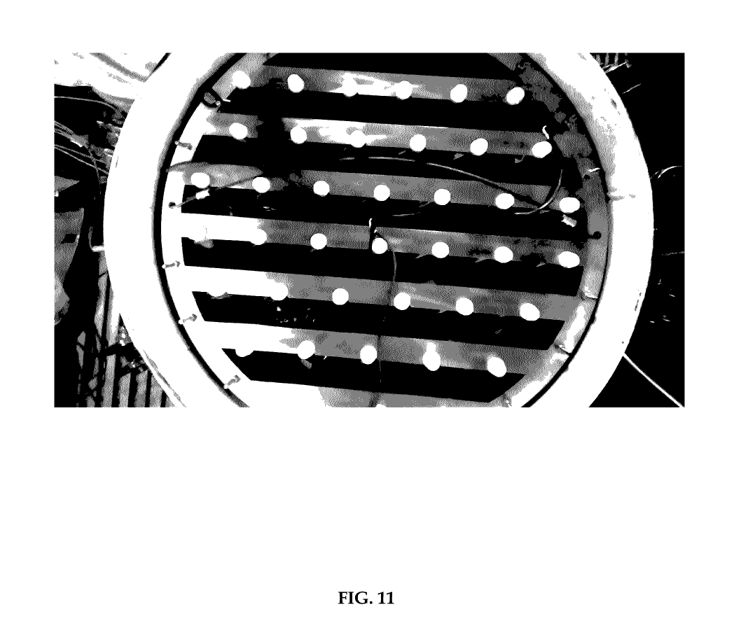

FIG. 10 is an example side support for a rack in a rack assembly. In some embodiments, the side supports may be used to connect a top section and a bottom section of the rack in the rack assembly. In some embodiments, the side supports may connect the rack assembly in a way that spacing between the top section and the bottom section is such that the pouches suspended from cutouts in the top section do not touch the bottom section.

FIG. 11 is an example top view of racks loaded in a retort. In some embodiments, pouches may be suspended from cutouts in a plate of a top section of the racks, such that there may be enough space for fluid flow, when the rack assembly may be placed in a retort.

Although only preferred embodiments of the invention have been specifically illustrated and described herein, it is to be understood that minor variations may be made without departing from the spirit of the invention.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A food processing retort apparatus comprising:
a housing configured to be substantially sealable;
a plate configured to be disposed within the housing, the plate including a plurality of empty portions, each of the plurality of empty portions having an elongated portion and a plurality of cutouts, wherein
each of the elongated portions have a first width, and
each of the cutouts have a second width, the first width being greater than the second width; and
a port within the housing that allows entry of a heating fluid into the housing to process contents of the retort.

2. The apparatus of claim 1, wherein the cutouts are shaped and configured to accept the geometry of a spout pouch fitment such that an open section within the fitment is slightly larger than the thickness of the plate.

3. The apparatus of claim 2, wherein the first width is greater than any diameter of the spout pouch fitment.

4. The apparatus of claim 2, wherein the first width is greater than any diameter of a cap in the fitment of the spout pouch.

5. The apparatus of claim 2, wherein during use a plurality of spout pouches are suspended vertically from the cutouts.

6. The apparatus of claim 2, wherein the first width is smaller than a part of the fitment of the spout pouch, and wherein the first width is larger than remaining parts of the fitment of the spout pouch.

7. The apparatus of claim 1, wherein the plate also includes holes whereby optional handles or cables are attached and can be used to lift the plate.

8. A food processing retort apparatus comprising:
a housing configured to be substantially sealable;
a rack disposed within the housing, the rack comprising a plurality of removable cross bars, each of the plurality of cross bars having cutout portions having a first width, wherein the plurality of cross bars are disposed relative to one another with a second width between two adjacent cross bars of the plurality of cross bars, and wherein the second width is greater than the first width; and
a port within the housing that allows entry of a heating fluid into the housing to process contents of the retort.

9. The apparatus of claim 8, wherein the cutouts are shaped and configured to accept the geometry of a spout pouch fitment such that an open section within the fitment is slightly larger than the thickness of the plate.

10. The apparatus of claim 9, wherein the first width is greater than any diameter of the spout pouch fitment.

11. The apparatus of claim 9, wherein the first width is greater than any diameter of a cap in the fitment of the spout pouch.

12. The apparatus of claim 9, wherein the first width is smaller than a part of the fitment of the spout pouch, and wherein the first width is larger than remaining parts of the fitment of the spout pouch.

13. The apparatus of claim 8, wherein the plate also includes holes whereby optional handles or cables are attached to lift the plate.

14. The apparatus of claim 9, wherein the spout pouches are suspended vertically from the cutouts.

15. A method of processing food products, the method comprising:
loading a plurality of spout pouches comprising a flexible receptacle and a fitment into a plurality of racks, each rack comprising a plate having a plurality of cross bars with cutouts, wherein the spout pouches are suspended into the racks from the cutouts;
filling the plurality of spout pouches with food materials through an opening within the fitment;
closing the opening within the fitment using a cap; and
loading the racks into a cooking retort to process the contents of the spout pouches by allowing a heating fluid including water and/or steam, to contact sides of the spout pouches.

16. The method of claim 15, wherein the spout pouches are suspended vertically from the cutouts.

17. The method of claim 15, wherein the plurality of cross bars in the rack, are removable.

18. The method of claim 15, wherein the cap includes hermetic closures.

19. The method of claim 15, wherein the plate also comprises a plurality of elongated empty sections, alternately placed with each of the plurality of cross bars, and wherein a width of each elongated empty section is greater than a width of each cutout.

20. The method of claim 19, wherein the width of each elongated empty section is smaller than a part of the fitment, and wherein the width of each elongated empty section is greater than a remaining part of the fitment.
